(19) United States
(12) Patent Application Publication
(10) Pub. No.: US 2008/0133474 A1
(43) Pub. Date: Jun. 5, 2008

(54) BIOINFORMATICS COMPUTATION USING A MAPRREDUCE-CONFIGURED COMPUTING SYSTEM

(75) Inventors: Ruey-Lung Hsiao, Los Angeles, CA (US); Ali Dasdan, San Jose, CA (US); Hung-Chih Yang, Sunnyvale, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/564,983

(22) Filed: Nov. 30, 2006

(51) Int. Cl. G06F 17/30

(52) U.S. Cl. 707/3; 707/E17.014

(57) ABSTRACT

A MapReduce architecture may be utilized for sequence alignment algorithm processing (such as BLAST or BLAST-like algorithms). In addition, a MapReduce architecture may be extended such that memory of the computing devices of a MapReduce-configured system may be shared between different jobs of sequence alignment and/or other bioinformatics algorithm processing, thereby reducing overhead associated with executing such jobs using the MapReduce-configured system.

### BACKGROUND

“MapReduce” is a programming framework that uses a particular programming paradigm, executed by a particularly-configured set of computing devices, to make it easier to obtain the benefits of parallel computing. That is, the MapReduce programming framework shields programmers from the burden of designing distributed algorithms and eases the pain of taking care of exceptions such as machine failures and lost connections.

An example of the MapReduce programming framework is described in “MapReduce: Simplified Data Processing on Large Clusters,” by Jeffrey Dean and Sanjay Ghemawat, appearing in OSDI'04: Sixth Symposium on Operating System Design and Implementation, San Francisco, Calif., December, 2004 (hereafter, “Dean and Ghemawat”). A similar, but not identical, presentation is also provided in HTML form at the following URL: http://labs.google.com/papers/mapreduce-osdi04-slides/index.html (hereafter, “Dean and Ghemawat HTML”).

In general, to use a MapReduce-configured system of computing devices (i.e., a system of computing devices configured to operate substantially according to a MapReduce framework), a programmer codes his algorithm in two different types of functions: Map( ) and Reduce( ). Stemming from its root of functional programming, the purpose of the map function is to generate a value or set of values given a key. The purpose of the reduce function is to combine a set of values into a single value. Specifically, a map function maps a (key,value) pair to intermediate key-value pairs and a reduce function combines a set of (key,value) pairs that have the same key value into a single (key,value) pair.

The decoupling of the data representation and algorithm facilitates the parallel execution of a program. That is, a programmer designs an algorithm without consideration of the parallel concept and the MapReduce-configured system handles the parallelization by partitioning the data and causing the data partitions to be handled in different computers of the MapReduce-configured system.

### SUMMARY

A MapReduce architecture may be utilized for BLAST-like algorithm processing. In addition, a MapReduce architecture may be extended such that memory of the computing devices of a MapReduce-configured system may be shared between different jobs of BLAST-like and/or other bioinformatics algorithm processing, thereby reducing overhead associated with executing such jobs using the MapReduce-configured system.

### BRIEF DESCRIPTION OF THE DRAWINGS

FIG. 1 illustrates a conventional architecture for accomplishing a BLAST algorithm.

FIG. 2 illustrates pseudo-code to accomplish a BLAST algorithm.

FIG. 3 is an example architecture of a MapReduce-configured system that may be utilized to process a genomic database to accomplish BLAST algorithm processing.

FIG. 4 illustrates slave computing devices each configured to load a corresponding data partition into its memory.

FIG. 5 shows a configuration of slave computing devices in which M (number of slave computing devices) is 6 and N (number of times a data partition is duplicated) is 1.

FIG. 6 illustrates that after task #1 has finished, the master computing device has dispatched another task—task #2—to work on the same pre-loaded data partition.

FIG. 7 illustrates a scenario in which part of Job #1 has finished (including task#1) and part of Job #2 has been dispatched by the master computing device.

FIG. 8 illustrates a scenario in which the same data partition is loaded to two different slave computing devices.

### DETAILED DESCRIPTION

Bioinformatics data analysis usually requires a large amount of computational power and, thus, it generally takes a long time to get a result of the analysis. This process may be speeded up by distributing the algorithm and running the distributed algorithm in a parallel manner, e.g., in a computer cluster. However, it is generally not a trivial task to design a distributed algorithm. Moreover, a parallel programming framework is often custom-tailored to solving a particular problem, which makes it difficult to use the same framework to solve another problem, even when the dataset on which the solution of the other problem is to be based is the same data set o which the solution to the particular problem is to be based.

As mentioned in the background, the MapReduce framework simplifies the parallelizing of an algorithm and lets programmers concentrate on the algorithm design. The MapReduce framework serves to decouple data from algorithms so that different algorithms can be executed in the same framework. This can be extremely useful in bioinformatics computing, since many algorithms, even though generally dissimilar, may be based on the same dataset.

As sequencing technology matures, the number of genomes that are completely sequenced has been increasing rapidly. Contrary to the traditional research methodology, researchers started to conduct cross-genome comparison and analysis in order to make inferences, such as conserved biological functions, evolutional path, and other inferences. Bioinformatics research relies heavily on efficient computation and analysis over a vast amount of biological data, such as genomic sequences, protein structures, or other biological data. Typically, algorithms used to analyze biological data have the complexity of exponential growth (with respect to data size), which makes instant query response difficult.

Among all the sequence analysis tasks, homology search may be one of the most fundamental and essential tasks. Due to a number of evolutionary mechanisms, such as mutation, natural selection and genetic drift, similar but non-identical sequences might be spawned from the same genomic segment. Sequences that seem different in their compositions might even produce similar protein structures and perform related biological functions. Hence, it is thought that identifying homology (and orthology) relationships gives more insights about the evolution.

Homology search involves looking for optimal matches between sequences. Common sequence alignment algorithms such as Needleman-Wunsch (global alignment) and Smith-Waterman (local alignment) use a dynamic programming approach to look for pair-wise alignments. The time (and space) complexity of these algorithms are O(MN), where M and N are the respective lengths of each sequence being aligned. These algorithms are generally less desirable to find alignments with sequences in large databases, due to the computationally-intensive nature of the algorithms.

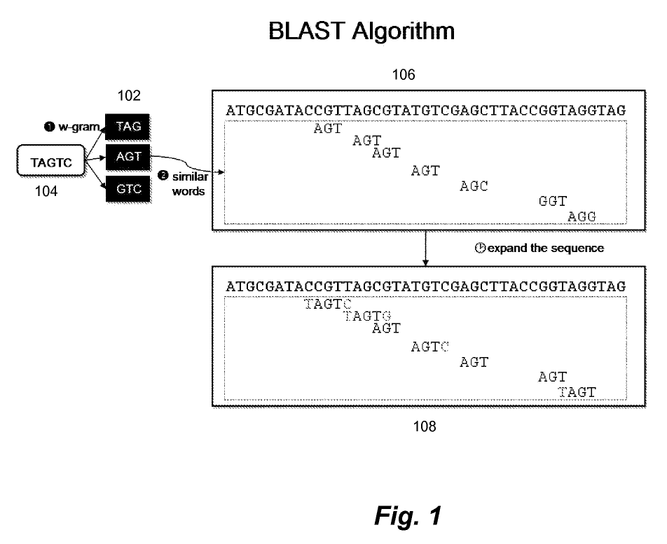

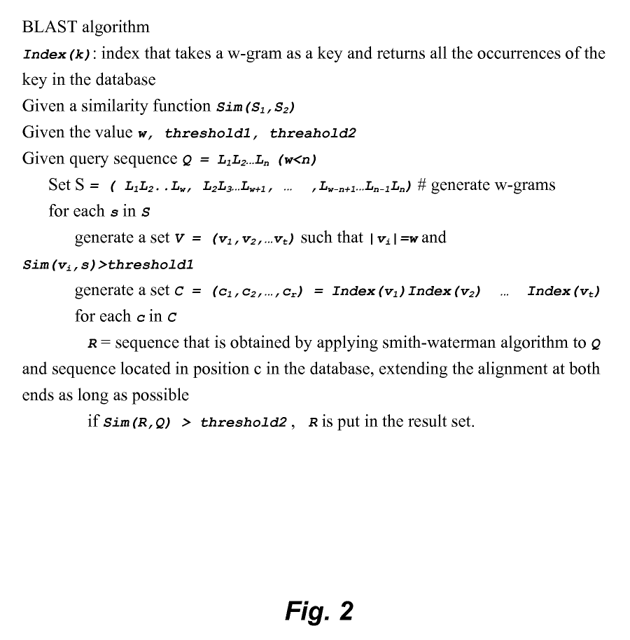

In order to make online alignment search more feasible, heuristic algorithms are often used to reduce the search space. Among those algorithms, BLAST (Basic Local Alignment Search Tool) is one of the most popular and important tools that are widely used among the bioinformatics community. FIG. 1 schematically illustrates the BLAST algorithm, and FIG. 2 shows an example of pseudo-code for the BLAST algorithm.

Other important sequence analysis tasks include gene finding, alternative splicing detection, etc. Although they are different from the sequence alignment algorithms (such as BLAST), they share some common characteristics: (1) these algorithms all aim at searching sub-sequences in the static database. (2) each algorithm defines an utility (or goodness-of-fit) function to determine which sub-sequences are qualified. (3) these algorithms can benefit dramatically in speed by partitioning the entire database into partitions. Here, we name these algorithms as sequence search algorithms. We will, however, use sequence alignment algorithms (such as BLAST) as examples even though our approach can be applied to all sequence search algorithms.

BLAST is a heuristic sequence alignment algorithm that finds local alignments with gaps between sequences. In order to reduce the search space, BLAST first finds small sequence segments in the database that are aligned well with a sequence segment of the same length in the query sequence. Then, BLAST extends these matched sequence segments at both ends and tries to elongate the alignment as long as possible. In this way, the search space may be dramatically reduced before the traditional alignment algorithm is executed. More specifically, the BLAST algorithm provides for a homology/orthology search by aligning sequences and selecting those alignments with similarity scores above a certain threshold.

Referring to FIG. 1, first, all possible w-gram words 102 are generated from the user query sequence (w is the word size, e.g., given by a user as a parameter). For each w-gram word, a table lookup is performed to find each w-gram word that can align to that w-gram and produces an alignment similarity score greater than a threshold.

Now, for each w-gram in the generated set of w-grams, that w-gram is found in an index. The index is a pre-built data structure that maps a w-gram to its location in genomic sequences. The index may be thought of as being similar to an inverted index used in text search. Using the index, all the occurrences (locations) of the w-gram are retrieved from the genome database. This is schematically illustrated by block 104 in FIG. 1. For each occurrence of a particular w-gram, the traditional alignment algorithm is started at both ends of this w-gram, and an optimal alignment is found. If this alignment is characterized by a score greater than a threshold (which may also be a user-configurable parameter), this alignment is output as the result of the BLAST algorithm. This is schematically illustrated by block 106 in FIG. 1.

In general, then, two pre-built structures are utilized by the BLAST algorithm: a table that may be used to map a particular w-gram to all w-grams that have an alignment similarity score greater than a threshold; and an index that may be used to map a given w-gram to its occurrences in the whole genomic database. These structures use a lot of storage, and a sophisticated cache mechanism may be used to make execution of the BLAST algorithm efficient.

In addition to the storage and data access issues, even current BLAST tools, with their use of heuristics, are very computationally intensive. Doing a homology search in a manner like a general web search can be even more time intensive. The desire for faster homology search is great because researchers are doing genome-wide (even cross-genome) alignments in a very large scale way.

In addition to the speed drawback, a lot of companies decide not to use publicly-available BLAST search engines due to security concerns, because the sequences are proprietary, and the companies do not want to risk disclosure to others. These companies typically resort to running the BLAST algorithm on local machines. In order to perform adequately, though, these machines should be relatively powerful with respect to computational speed and storage.

BLAST search can be performed locally by running BLAST algorithms over genomic data that is stored locally to the computer processing the genomic data. This may result in an adequate response time (such as if the system has enough resources such as faster CPU, more memory, etc). However, there are some drawbacks to this approach: (1) Genomic data should generally be synchronized between a centralized genomics database and the local storage to keep it updated. This may bring its own set of time consequences. (2) The performance requirements for the local system are generally relatively high. In order to have better performance, fast disk I/O and a large amount of memory should be used. There can be a tradeoff to consider when determining where the data should reside. (3) Data caching typically plays an important role on these systems, because it can potentially decrease the response time dramatically. However, a good cache system and policy may depend heavily on the system configuration and can be difficult to fine tune.

Parallel computing is often exploited to reduce the total computation time. A parallel version of the BLAST algorithm is designed with the consideration of the hardware configuration on which the algorithm is to be executed. Due to the enormous amount of data involved, parallel computing may be a practically essential approach to any large-scale bioinformatics data analysis, including sequence alignment. Nowadays, most large-scale BLAST searches use a parallel computing architecture in some way.

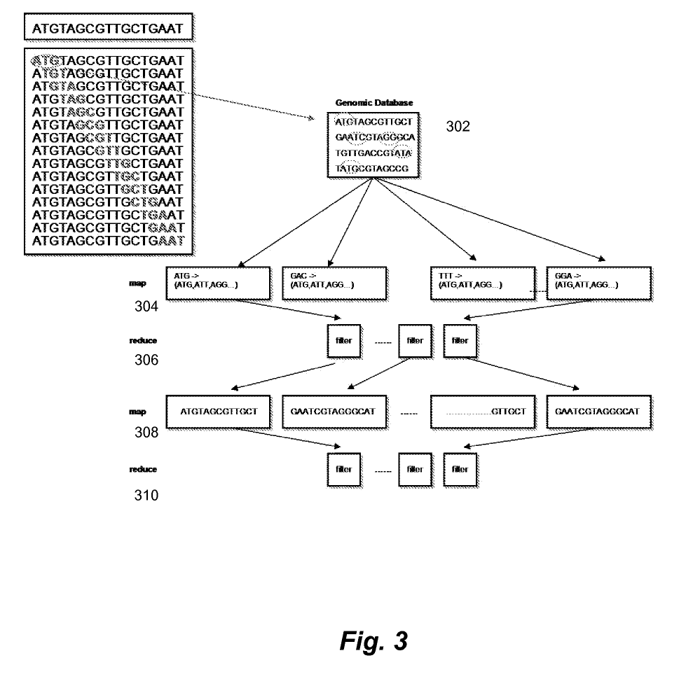

Referring to the FIG. 3 example, the inventors have realized that a MapReduce-configured system may be utilized to process a genomic database 302 to accomplish BLAST algorithm processing. As can be seen from FIG. 3, for example, a map function 304 is used to determine all occurrences of the w-grams from the genomic database 302. The reduce function 306 partitions the results and provides them to a map function 308, which finds optimal alignments for each occurrence of the w-gram. The reduce function 310 provides all alignments that are characterized by a score greater than a threshold (which may be a user-configurable parameter). Each computing device of the MapReduce-configured system has its own partition of the genome database and index and, thus, it is possible to store all the index and database in the memory of the computing devices to achieve high throughput.

Furthermore, the inventors have realized that the MapReduce-configured system can be configured to efficiently address multiple bioinformatics problems that use the same dataset. More particularly, the inventors have realized that most bioinformatics data analyses are essentially doing search (both exact search and similarity search) against a very large but static search space formed by the same data, such as genomic data. The data can be partitioned such that each partition is independent of the other partitions, which can facilitate large scale parallel computing, since an individual processing flow generally need not to wait for another processing flow.

This data independence property is very important and very useful for a generic bioinformatics data analysis environment, since it implies that algorithms can be conceptually separated from data, as well as one data partition being conceptually separate from another data partition. In other words, the search space can be divided into smaller pieces and each computing device of a MapReduce-configured system may work on its own portion of data. In addition, since a lot of algorithms work on the same search space (formed by the same set of genome sequences), hence a generic, parallel computing framework can be extremely useful for analysis for multiple purposes. Different algorithm components can be plugged into the system and perform their respective search functionality over the same search space.

Since data are partitioned into small pieces, data partitions can be put into main memory in each machine of a large computer cluster, assuming the partition can fit into the memory space of the machine. Pre-built BLAST data structures, such as a w-gram occurrence table, can be stored in the memory, and the search can be done from memory.

One of the major problems of BLAST is that the w (word size) is limited to a small number of values (typically 3, 7, 11, etc). The reason for this limitation is that an index would be built for each w value, and the size of the index can easily be very large. With the in-memory data partitioning, the w-gram index need not even be built, because it is affordable to execute the alignment algorithm in memory. Another benefit of this architecture is that no sensitivity is lost, like with a conventional BLAST algorithm that lowers sensitivity in order to speed up the search.

The MapReduce framework provides a generic framework that can be supplied with different map and reduce functions for different purposes, which is very suitable for performing the BLAST algorithm. By dividing up the whole genomic database into smaller pieces, a MapReduce-configured system is able to implement a search for similar sequences very fast. In addition, since there are smaller pieces of the database in each machine, the genomics data and corresponding index structure can be stored into the memory of each machine. This is much simpler than the standard cache mechanism, for example, with the concomitant replacement processing and other complicating overhead.

In accordance with some examples, a MapReduce-configured system for bioinformatics processing is different from a conventional MapReduce-configured system in a way that has a significant effect on efficiency, to support data sharing among different executions of bioinformatics algorithms (even different algorithms, that operate on the same data). For example, each slave computing device may be assigned to load a particular chunk of genomic data partition when that slave computing device starts up or upon some other triggering event. Afterwards, this slave computing device may be tasked with running algorithms implemented in the map function against the chunk of genomic data partition that the slave loaded.

Reduce tasks need not be run in machines that have a genomic data partition, since the reduce task aggregates the mapping results and does not operate directly on the genomic data.

Each slave computing device in the MapReduce-configured system may otherwise work the same way as with a conventional MapReduce-configured system except, as just discussed, that the slave computing device provides a memory in which the genomics data is static, such that the genomics data can be accessed by mapping functions of succeeding executions of bioinformatics algorithms. In this way, slave computing devices can load the genomic data partitions into memory and each Map/Reduce function (i.e., to implement different bioinformatics algorithms or even to implement different executions of the same bioinformatics algorithm) can work on the same set of data.

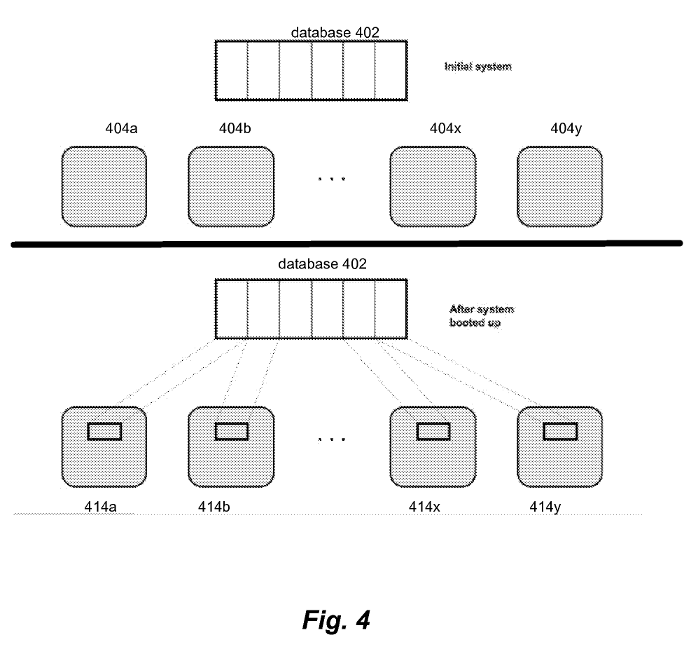

FIGS. 4 to 8 illustrate an example of the data sharing mechanism.

In accordance with the example, during the bootup of the computing devices of the MapReduce-configured system (or based on some other triggering event, like a system reset), master and slave computing devices initialize information such as is described in Dean and Ghemawat and Dean and Ghemawat HTML. To implement the data-sharing mechanism, the slave computing devices are also each configured to load a corresponding data partition (typically, pre-defined) into its memory. This is illustrated in FIG. 4 where it is shown that, before initialization of the slave computing devices 404a, 404b, . . . , 404x and 404y, the data partitions of the genomics database 402 have not yet been loaded into the memories of the slave computing devices (generically, 404). After initialization, the data partitions of the genomics database 402 have been loaded into the memories of the slave computing devices (now indicated as 414a, 414b, . . . , 414x and 414y.

The mapping between each slave computing device and data partition that slave computing device loads into its memory may be a system-wide configuration decision. For example, the mapping may be defined by the system configuration such that there are at least N (pre-defined parameter) slave computing devices that load any given data partition. This pertains to data duplication, which is now discussed.

That is, in one example, after the system initialization process, the mapping between a slave computing device and the data partition is monitored, and possibly manipulated, by a master computing device. For example, in the presence of a slave computing device failure and, for the data partitions held by the failed slave computing device, the number of those data partitions system wide becomes lower than the predefined parameter N, the master computing device may request a selected slave computing device to load one or more of those data partitions into its memory in order to replace that failed slave computing device, with respect to that data partition in order to maintain system stability.

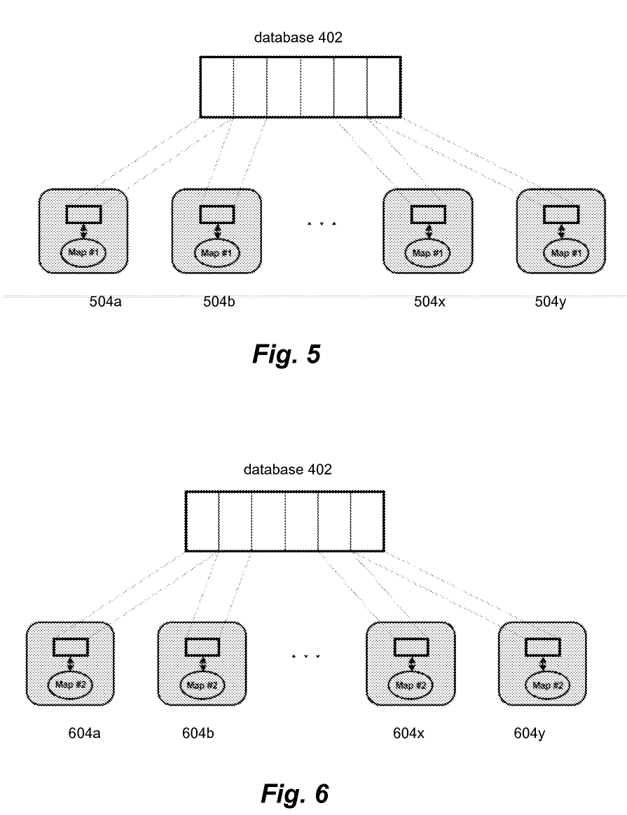

For example, the number of data partitions may be M, with each bioinformatics MapReduce job being then executed in M slave computing devices when submitted. The master computing device decides which M slave computing devices are to execute the job, under the condition that the union of the data partitions covers the whole genomic database. FIG. 5 shows one configuration in which M is 6 and N is 1. The slave computing devices (generically 504) are configured to, together, execute a Map #1 MapReduce job.

During the execution of any MapReduce job, each mapper task accesses its data from the memory of the slave computing device in which that task is executing. The execution environment in each slave computing device may provide a function call for the tasks to locate and access the data in the memory. FIG. 5 shows the interaction between tasks and data in slave computing devices.

In one example, when a MapReduce job finishes, the slave computing device does not clear its memory. Rather, the data partition is kept intact and ready to serve another dispatched Map/Reduce job that is going to work on this data partition. Hence, the data loading process may be minimized during each MapReduce job session. FIG. 6 is an illustration of this, showing that after task #1 has finished, the master computing device has dispatched another task—task #2—to work on the same pre-loaded data partition. (The slave computing devices 504 are the same slave computing devices as the slave computing devices 604 indicated in FIG. 6, but now configured to execute task #2).

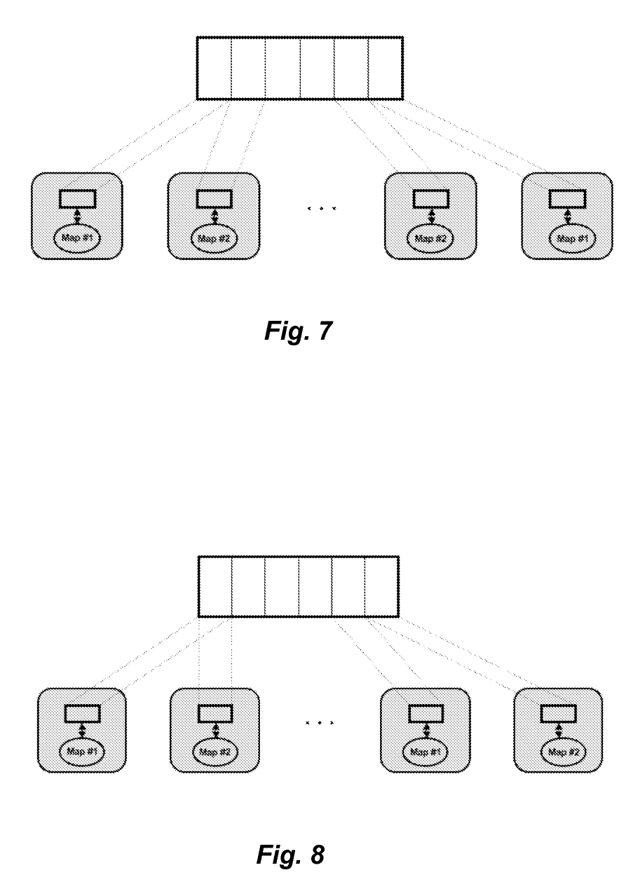

FIG. 7 illustrates a scenario in which part of Job #1 has finished (including task#1) and part of Job #2 has been dispatched by the master computing device.

In other examples, particular data is replicated among multiple slaves, so the Master can efficiently dispatch MapReduce tasks to slaves that have less workload. FIG. 8 illustrates a scenario in which the same data partition is loaded to two different slave computing devices. In this case, the master computing device can make use of this replication and dispatch different jobs to run on the same data partition.

Generally, the choice of the data partition that is loaded in the slave may be determined by data locality. Since the underlying distributed file system has its duplication mechanism, there may be a general optimization (in terms of speed) if (1) the genomic database is partitioned in a unit that is multiple of the size of the chunk size in the file system (2) the slave machine loads the data partition that is stored, in the underlying distributed file system, in that same slave machine.

As in the conventional MapReduce architecture, the master computing device may monitor the progress of the map/reduce job, including the “hello” message from slave computing devices. In one example, in accordance with the discussion above, when the master computing device detects the failure of any particular slave computing device, the job that was performed by that failed slave computing device may be reassigned to other computing devices that already have the same genomic data partition as the failed slave computing device.

Different alignment algorithms can be implemented in the Map/Reduce functions. In addition to alignment algorithms, other search-related genomic algorithms—such as looking for ORF (open reading frame), gene detection, alternative splicing detection can also be implemented in the map/reduce function without changing the underlying database architecture. These all use the same underlying database, and the MapReduce architecture is general to the algorithm.

While the discussion of examples herein has been primarily with respect to genomics data, the discussion may also apply to other appropriate biological data, such as mentioned earlier in this description.

We have thus described an example of a MapReduce architecture that is particularly well-suited for accomplishing bioinformatics algorithms. For example, the described example provides scalability to distributed bioinformatics data processing far more significantly than currently available. The MapReduce architecture enables the implementation of distributed bioinformatics data processing on large clusters of cheap/commodity computing devices, such as in data centers. The programming interface may be simplified, since programmers can concentrate on the algorithm without being concerned about implantation details such as machine failure and memory problems. The throughput may be dramatically increased by parallelizing sequence search and by reducing the search space. I/O may be reduced dramatically because, in practicality, each machine “owns” a partition of the database. In most cases, the sequence data may be maintained in memory, so additional I/O may be avoided. If each machine has a reasonable amount of memory (for example, 2 Gb), the whole sequence database can even collectively exist in the memory of the machines. Performance boost can be highly achieved. Web search-like sequence alignment query can be realized.

1. A method of operating computing devices of a MapReduce-configured system of a plurality of computing devices to accomplish sequence search processing of a query sequence relative to a collection of genomic data, wherein the query sequence is characterized by a plurality of w-grams, the method comprising:
a) causing computing devices of the MapReduce-configured system to execute a mapping function to determine occurrences of the w-grams in the collection of genomic data;
b) causing computing devices of the MapReduce-configured system to execute a reducing function to partition the determined occurrences of the w-grams;
c) causing computing devices of the MapReduce-configured system to execute a mapping function to find, in the collection of genomic data, optimal matches for the determined occurrences of the w-grams; and
d) causing computing devices of the MapReduce-configured system to execute a reducing function to provide optimal matches characterized by an utility score greater than a particular utility score threshold.

2. The method of claim 1, further comprising:
receiving a value for the particular utility score threshold.

3. The method of claim 1, further comprising:
prior to steps a) to d), loading partitions of the genomic data into memory of the computing devices.

4. The method of claim 3, further comprising:
repeating steps a) to d) for a different query sequence, substantially without reloading the portions of the genomic data into the memory of the computing devices.

5. The method of claim 1, wherein:
the sequence search algorithm processing is a sequence alignment processing.

6. (canceled)

7. A computing system comprising a MapReduce-configured system of a plurality of computing devices to accomplish sequence search processing of a query sequence relative to a collection of genomic data, wherein the query sequence is characterized by a plurality of w-grams, the computing system configured to:
a) cause computing devices of the MapReduce-configured system to execute a mapping function to determine occurrences of the w-grams in the collection of genomic data;
b) cause computing devices of the MapReduce-configured system to execute a reducing function to partition the determined occurrences of the w-grams;
c) cause computing devices of the MapReduce-configured system to execute a mapping function to find, in the collection of genomic data, optimal alignments for the determined occurrences of the w-grams; and
d) cause computing devices of the MapReduce-configured system to execute a reducing function to provide optimal alignments characterized by an utility function score greater than a particular score threshold.

8. The computing system of claim 7, further configured to:
receive a value for the particular score threshold.

9. The computing system of claim 7, further configured to:
load partitions of the genomic data into memory of the computing devices.

10. The computing system of claim 9, further configured to:
operate on a different query sequence, substantially without reloading the portions of the genomic data into the memory of the computing devices.

11. The computing system of claim 7, wherein:
the sequence alignment algorithm processing is a sequence search processing.

12. A method of operating computing devices of a MapReduce-configured system of a plurality of computing devices to accomplish bioinformatics processing of a collection of biological data, comprising:
upon occurrence of a trigger event, causing a separate portion of the biological data to be loaded into memory associated with a corresponding respective computing device of the MapReduce-configured system;
causing a first bioinformatics algorithm processing to be collectively accomplished by the computing devices of the MapReduce-configured system;
causing a second bioinformatics processing to be collectively accomplished by the computing devices of the MapReduce-configured system, each computing device operating on a same separate portion of the biological data on which that computing device operated for the first bioinformatics algorithm processing, substantially without reloading that separate portion into the memory of that computing device after beginning processing of the first bioinformatics algorithm at least until ending processing of the second bioinformatics algorithm.

13. The method of claim 12, further comprising:
for each of the computing devices, providing to the first bioinformatics algorithm processing and to the second bioinformatics processing, an indication of where in the memory of that computing device the separate portion of the biological data is held.

14. The method of claim 12, wherein:
for each of at least some of the separate portions of the biological data,
that separate portion is held in the memory of more than one of the computing devices of the MapReduce-configured system; and
the method further comprises allocating bioinformatics processing, of the first bioinformatics algorithm or of the second bioinformatics algorithm, on that separate portion to one of the more than one computing devices.

15. The method of claim 14, wherein the allocating is according to a load-balancing algorithm.

16. The method of claim 14, further comprising:
for each of at least some of the separate portions of the biological data,
ensuring that separate portion is held in the memory of at least a particular number of the computing devices of the MapReduce-configured system.

17. The method of claim 16, further comprising:
receiving a value to configure that particular number.

18. The method of claim 12, wherein:
the trigger event is bootup of the computing devices of the MapReduce-configured system.

19. The method of claim 12, wherein:
the first bioinformatics algorithm processing is sequence search algorithm processing with respect to a first query sequence and the second bioinformatics algorithm processing is a sequence search processing with respect to a second query sequence.

20. The method of claim 12, wherein:
the sequence search algorithm processing is any search algorithm that searches matches against a static database.

21. At least one computing device configured to perform the method of claim 12.

22.-29. (canceled)

30. A method of configuring a data processing system to perform sequence search algorithm processing of a query sequence with respect to a genomics data set, the method comprising:
configuring the data processing system to include a mapping function that configures the data processing system to determine occurrences of the w-grams in the collection of genomic data;
configuring the data processing system to include a reducing function that configures the data processing system to partition the determined occurrences of the w-grams;
configuring the data processing system to include a mapping function that configures the data processing system to find, in the collection of genomic data, optimal alignments for the determined occurrences of the w-grams; and
configuring the data processing system to include a mapping function that configures the data processing system to provide optimal solutions characterized by an utility score greater than a particular utility score threshold.

31. The method of claim 30, further comprising:
configuring the data processing system to load partitions of the genomics data set into memories of computing devices of the data processing system.

32. The method of claim 31, wherein:
the query sequence is a first query sequence; and
the method further comprises configuring the data processing system to perform sequence search algorithm processing of another query sequence with respect to the genomics data set, including configuring the data processing system to not reload the partitions of the genomics data set prior to performing the sequence search algorithm processing of the second query sequence.

33. The method of claim 30, further comprising:
processing the query sequence, by the configured data processing system.

34. The method of claim 30, wherein:
The sequence alignment algorithm processing is sequence search processing.
